(19) United States
(12) Patent Application Publication
(10) Pub. No.: US 2025/0018961 A1
(43) Pub. Date: Jan. 16, 2025

(54) Vehicle Control Device, Vehicle Control Method, and Vehicle Control System

(71) Applicant: Hitachi Astemo, Ltd., Hitachinaka-shi, Ibaraki (JP)

(72) Inventor: Kentaro UENO, Hitachinaka-shi, Ibaraki (JP)

(21) Appl. No.: 18/687,590

(22) PCT Filed: Jul. 12, 2022
(86) PCT No.: PCT/JP2022/027368

§ 371 Date: Sep. 13, 2024

(30) Foreign Application Priority Data
Sep. 9, 2021 (JP) 2021-146582

(51) Int. Cl. B60W 50/08; B60W 60/00

(52) U.S. Cl. CPC B60W 50/085; B60W 60/001; B60W 2520/10; B60W 2520/125; B60W 2540/18; B60W 2552/20; B60W 2554/802

(57) ABSTRACT

A vehicle control device, a vehicle control method, and a vehicle control system according to one aspect of the present invention switch, when vehicle forward information satisfies a predetermined condition, a control command to be output to an actuator unit for controlling the motion of a vehicle from a first control command, which is a control command related to driver assistance or autonomous driving of the vehicle, to a second control command, which is a control command for setting the vehicle in motion based on an indicator different from that of the first control command. As a result, the present invention can add abilities corresponding to different indicators such as ride comfort when the vehicle is traveling on the basis driving assistance or autonomous driving.

### TECHNICAL FIELD

The present invention relates to a vehicle control device, a vehicle control method, and a vehicle control system.

### BACKGROUND ART

Patent Document 1 discloses a drive trajectory generating apparatus. The drive trajectory generating apparatus produces a drive trajectory satisfying the transit time and other driving conditions demanded by the driver, and includes a first convergence calculation section that produces a drive trajectory by performing a convergence calculation so as to achieve a first constraint condition based on a predetermined target passing time and road boundaries, and a drive trajectory producing section that produces a drive trajectory, in a state achieving the first constraint condition, by performing a convergence calculation of an evaluation function that gives priority to a predetermined driving condition.

### REFERENCE DOCUMENT LIST

### Patent Document

Patent Document 1: JP 2009-115464 A

### SUMMARY OF THE INVENTION

### Problem to be Solved by the Invention

In recent years, driver assistance technologies called Advanced Driver Assistance System (ADAS) or Autonomous Driving (AD) with functions such as Lane Keeping Assist (LKA) and Adaptive Cruise Control (ACC) have been developed.

However, functions such as LKA and ACC are not intended to control vehicle motion in consideration of ride quality for occupants, and accordingly, an increase in acceleration in a left-right direction or jerk in a left-right direction may deteriorate ride quality for occupants, depending on driving conditions.

The present invention has been made in view of such conventional circumstances, and an object of the present invention is to provide a vehicle control device, a vehicle control method, and a vehicle control system that can provide additional performance associated with different indicators, such as comfortable ride quality, when a vehicle is traveling with driver assistance or by autonomous driving.

### Means for Solving the Problem

According to an aspect of the present invention, when forward information of a vehicle satisfies a predetermined condition, a control command to be output to an actuator unit for controlling motion of the vehicle is switched from a first control command, which is a control command related to driver assistance or autonomous driving of the vehicle, to a second control command, which is a control command for setting the vehicle in motion based on an indicator different from that of the first control command.

### Effects of the Invention

According to the present invention, it is possible to provide additional performance associated with different indicators, such as comfortable ride quality, when a vehicle is traveling with driver assistance or by autonomous driving.

### BRIEF DESCRIPTION OF THE DRAWINGS

FIG. 1 is a block diagram illustrating a vehicle control system.

FIG. 2 illustrates a path, vehicle velocity, acceleration, and jerk in driving by LKA and ACC.

FIG. 3 illustrates a path, vehicle velocity, acceleration, and jerk in driving under a ride quality control.

FIG. 4 is a block diagram illustrating a specific configuration of the vehicle control system.

FIG. 5 illustrates an overview of trajectory planning.

FIG. 6 illustrates an example of trajectory calculation based on trajectory planning.

FIG. 7 illustrates setting of the vehicle velocity, acceleration, and jerk by trajectory planning.

FIG. 8 illustrates the first embodiment of a trajectory switching process.

FIG. 9 illustrates the second embodiment of the trajectory switching process.

FIG. 10 illustrates the third embodiment of the trajectory switching process.

FIG. 11 is a block diagram illustrating a configuration of a trajectory tracking control unit.

FIG. 12 is a flowchart illustrating a determination process for intervention conditions of a ride quality control.

FIG. 13 is a time chart illustrating a switching process from a second control command to a first control command.

FIG. 14 is a system block diagram illustrating a case in which an ADAS-ECU has a ride quality control function.

### MODE FOR CARRYING OUT THE INVENTION

Hereinafter, embodiments of a vehicle control device, a vehicle control method, and a vehicle control system according to the present invention will be described with reference to the drawings.

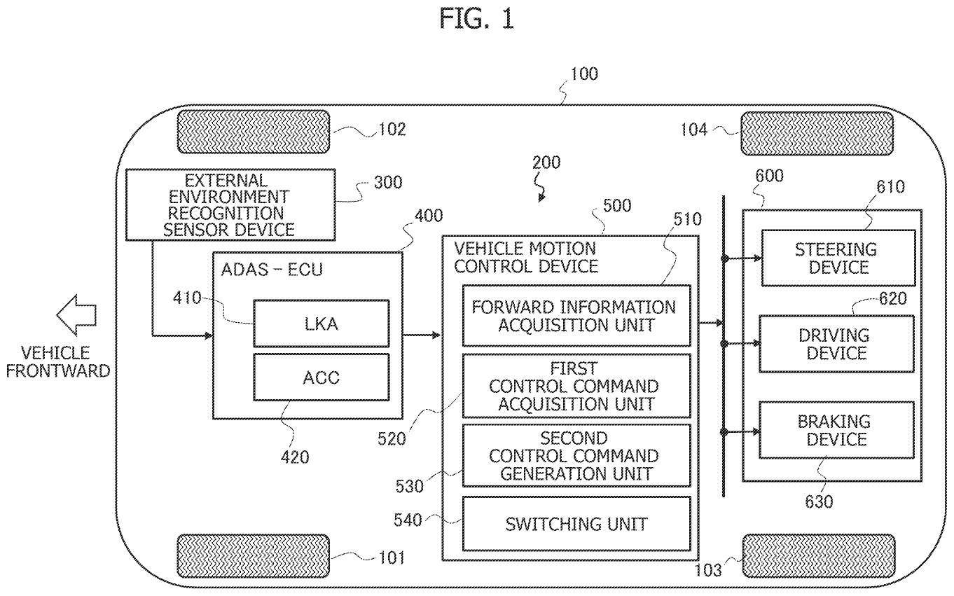

FIG. 1 is a schematic diagram illustrating an aspect of a vehicle control system 200 mounted on a vehicle 100, which is a four-wheeled vehicle.

Vehicle control system 200 includes an external environment recognition sensor device 300, a driver assistance control unit 400 (hereinafter, referred to as ADAS-ECU 400) serving as a first control unit, a vehicle motion control device 500 serving as a second control unit, and an actuator unit 600.

External environment recognition sensor device 300 detects and recognizes the external information about vehicle 100 and includes cameras such as a stereo camera, a monocular camera, and a 360-degree camera.

External environment recognition sensor device 300 outputs information on road marking lines and road shoulders of the road on which vehicle 100 is traveling and information on a preceding vehicle.

Actuator unit 600 for controlling the motion of vehicle 100 has a steering device 610, a driving device 620, and a braking device 630.

Steering device 610 includes a steering actuator, such as a motor, for varying the direction of front wheels 101, 102 which are steered road wheels, i.e., for varying the turning angle. Steering device 610 is an electronically controlled power steering device or a steer-by-wire steering device that can vary the turning angle by electronic control of the steering actuator.

Driving device 620 transmits a driving force generated by a power source, such as a motor or an internal combustion engine, to front wheels 101, 102 and/or rear wheels 103, 104 of vehicle 100. Driving device 620 can vary the driving force through, for example, electronic control of the power supplied to the motor, or electronic control of the throttle of the internal combustion engine.

Braking device 630 includes, for example, an electric hydraulic pump serving as an energy source. Braking device 630 can vary the braking force applied to wheels 101 to 104 through electronic control of the hydraulic pressure supplied to the brake cylinders of wheels 101 to 104.

Braking device 630 is not limited to a hydraulic or friction braking device, and vehicle control system 200 may use, as braking device 630, a braking device that moves brake pads in a motor-driven manner, or may use, for braking device 630, regenerative braking by a motor serving as driving device 620, for example.

ADAS-ECU 400 is an electronic control device including a microcomputer (computational processing unit) that performs calculation in accordance with acquired information and outputs the calculation results accordingly.

ADAS-ECU 400 acquires, for example, from external environment recognition sensor device 300, various types of information including forward information of vehicle 100, and generates a control command for controlling actuator unit 600 (hereinafter, referred to as first control command).

The control command for controlling actuator unit 600 includes a steering command output to steering device 610, a driving command output to driving device 620, and a braking command output to braking device 630.

Here, the steering command is a steering torque command or a turning angle command, the driving command is a driving torque command, and the braking command is a command such as a braking torque command, a hydraulic pressure command, and a brake pressure command.

ADAS-ECU 400 has a function of controlling actuator unit 600 to assist the driving operation of the driver of vehicle 100. The first control command generated by ADAS-ECU 400 is a control command to provide driver assistance.

ADAS-ECU 400 includes a Lane Keeping Assist function 410 (hereinafter, referred to as LKA function 410) and an Adaptive Cruise Control function 420 (hereinafter, referred to as ACC function 420) as a driver assistance function.

LKA function 410 is a driver assistance function of keeping vehicle 100 centered in the lane and suppressing lane deviation by a steering control based on detection and recognition of road marking lines and road shoulders.

That is, LKA function 410 controls the lateral position of vehicle 100, in other words, the position of vehicle 100 in the width direction of the road or lane, and causes vehicle 100 to track a path along the road shape.

ACC function 420 is a function of controlling the braking force on the basis of detection and recognition of an inter-vehicle distance, i.e., the distance between vehicle 100 and the preceding vehicle, and is basically used together with LKA function 410.

ACC function 420 is a driver assistance function that causes vehicle 100 to travel at a constant set velocity and that, when vehicle 100 approaches the preceding vehicle, causes vehicle 100 to automatically accelerate and decelerate to follow the preceding vehicle while maintaining an appropriate inter-vehicle distance.

If either one of LKA function 410 and ACC function 420 provides driver assistance, it is called level 1 autonomous driving, and if both of LKA function 410 and ACC function 420 provide driver assistance to cause vehicle 100 to follow the preceding vehicle while keeping the lane, it is called level 2 autonomous driving.

That is, ADAS-ECU 400 is a control unit that has a control function of implementing the level 1 or level 2 autonomous driving of which the driving entity is a human, and that includes a first control command generation unit for generating a first control command, which is a control command related to driver assistance or autonomous driving.

Vehicle motion control device 500 is an electronic control device including a microcomputer (in other words, computational processing unit) that performs calculation in accordance with acquired information and outputs the calculation results accordingly.

Vehicle motion control device 500 is a vehicle control device that includes a forward information acquisition unit 510, a first control command acquisition unit 520, a second control command generation unit 530, and a switching unit 540. Vehicle motion control device 500 outputs a control command to an actuator unit 600 to control the motion of vehicle 100.

Forward information acquisition unit 510 acquires forward information of vehicle 100 detected and recognized, for example, by external environment recognition sensor device 300. That is, in the vehicle motion control, forward information acquisition unit 510 performs a step of acquiring forward information of vehicle 100.

First control command acquisition unit 520 acquires the first control command, which is the control command generated by LKA function 410 and ACC function 420 of ADAS-ECU 400. That is, in the vehicle motion control, first control command acquisition unit 520 performs a step of acquiring the first control command.

Second control command generation unit 530 plans a trajectory capable of providing a comfortable ride quality and generates a control command for actuator unit 600 to cause vehicle 100 to track the planned trajectory (hereinafter, referred to as second control command). That is, in the vehicle motion control, second control command generation unit 530 performs a step of generating the second control command.

The trajectory generated by second control command generation unit 530 includes information on the path and vehicle velocity.

Here, second control command generation unit 530 plans a trajectory capable of providing a comfortable ride quality by planning the trajectory using, as a condition, acceleration in the left-right direction of vehicle 100 or jerk in the left-right direction of vehicle 100.

In other words, second control command generation unit 530 plans a trajectory in consideration of acceleration in the left-right direction of vehicle 100 or jerk in the left-right direction of vehicle 100 such that predetermined ride quality conditions can be satisfied.

As mentioned above, the first control command is related to the path along the road shape, inter-vehicle distance, or set-velocity, whereas the second control command is related to the trajectory planned using, as a condition, acceleration in the left-right direction of vehicle 100 or jerk in the left-right direction of vehicle 100.

That is, second control command generation unit 530 generates the second control command, which is a control command for setting the vehicle in motion based on an indicator different from that of the first control command.

Hereinafter, the vehicle control based on the second control command is referred to as “ride quality control”.

When the forward information of vehicle 100 satisfies a predetermined condition, switching unit 540 switches the control command to be output to actuator unit 600 from the first control command generated by ADAS-ECU 400 to the second control command generated by second control command generation unit 530. That is, in the vehicle motion control, switching unit 540 performs a step of switching the control command from the first control command to the second control command.

That is, switching unit 540 provides additional performance for “comfortable ride quality”, an indicator different from that of driver assistance, when a vehicle is traveling with driver assistance by LKA function 410 and ACC function 420.

In other words, by switching the control command from the first control command to the second control command, switching unit 540 can improve ride quality when the driver assistance by LKA function 410 and ACC function 420 is provided.

As will be described in detail later, switching unit 540 determines whether to switch the control command on the basis, for example, of information on the road curvature as the forward information of vehicle 100 and information on whether a predetermined vehicle motion is required.

Switching unit 540 and/or second control command generation unit 530 may have a function of transiently processing the control command to be output to actuator unit 600 for a smooth transition between the vehicle motion control state based on the first control command (in other words, driver assistance state) and the vehicle motion control state based on the second control command (in other words, ride quality control state).

A vehicle motion with a comfortable ride quality means, for second control command generation unit 530, a vehicle motion in which acceleration in the left-right direction (i.e., the lateral direction) of vehicle 100 and jerk in the left-right direction of vehicle 100 are each suppressed within a predetermined range.

In order to achieve such vehicle motion with a comfortable ride quality, second control command generation unit 530 plans a trajectory capable of reducing acceleration and jerk in the left-right direction in accordance with a constantly varying drivable area, and generates the second control command to cause vehicle 100 to track the planned trajectory.

The drivable area is an area within the lane of the road ahead of vehicle 100, in which a margin to the road marking lines (i.e., lane boundary) is secured, obstacles are avoided, and the inter-vehicle distance to the preceding vehicle is secured.

When vehicle 100 is traveling at a constant velocity or following the preceding vehicle while keeping in the lane by LKA function 410 and ACC function 420, acceleration and jerk in the left-right direction are generated depending on the road shape and vehicle velocity.

On the other hand, second control command generation unit 530 appropriately plans a trajectory by simultaneously calculating the vehicle velocity, which corresponds to the path and at which acceleration and jerk can be reduced, and the path, which effectively uses the road width and corresponds to the vehicle velocity, thereby reducing acceleration and jerk in the left-right direction of vehicle 100, resulting in improving ride quality for the passengers.

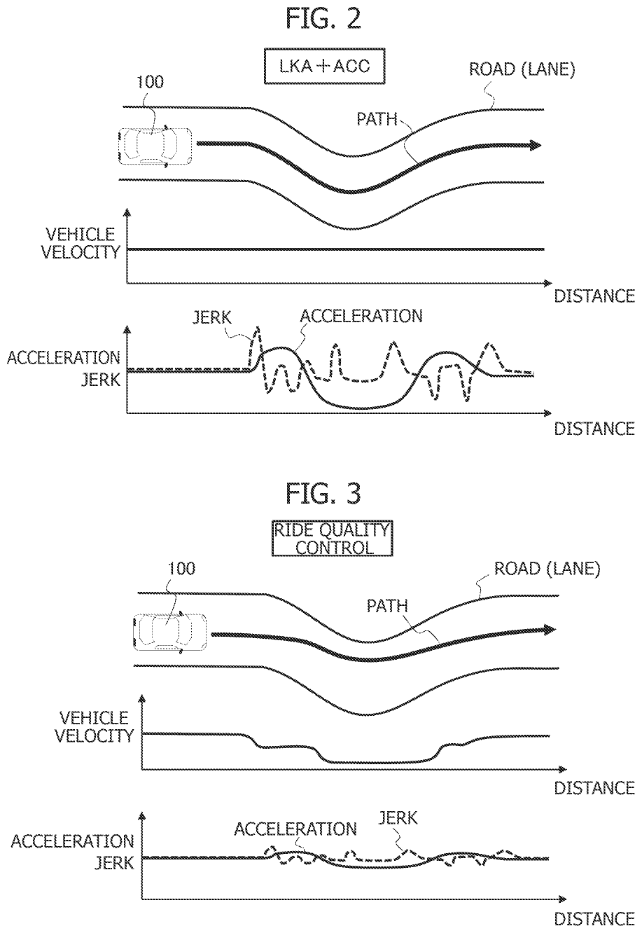

FIG. 2 exemplary illustrates the vehicle velocity, acceleration in the left-right direction, and jerk in the left-right direction of vehicle 100 traveling at a constant velocity while keeping in the lane by LKA function 410 and ACC function 420.

FIG. 3 exemplary illustrates the vehicle velocity, acceleration in the left-right direction, and jerk in the left-right direction of vehicle 100 traveling on the same road as in FIG. 2 with the ride quality control intervening.

When vehicle 100 travels at a constant velocity along a path according to the road shape (approximate middle of the lane) with the driver assistance by LKA function 410 and ACC function 420, acceleration and jerk in the left-right direction of vehicle 100 become larger at a place where the road is curved, i.e., at a curve (FIG. 2).

On the other hand, under the ride quality control, the vehicle velocity, which corresponds to the path and at which acceleration and jerk can be reduced, and the path, which effectively uses the road width and corresponds to the vehicle velocity, are simultaneously calculated. As a result, a path capable of reducing the turning angle is set, and the vehicle velocity is reduced in accordance with the increase in the road curvature (see FIG. 3).

Thus, even where the road curves, acceleration in the left-right direction and jerk in the right-right direction can be suppressed, resulting in improving ride quality for the passengers of vehicle 100 (see FIG. 3).

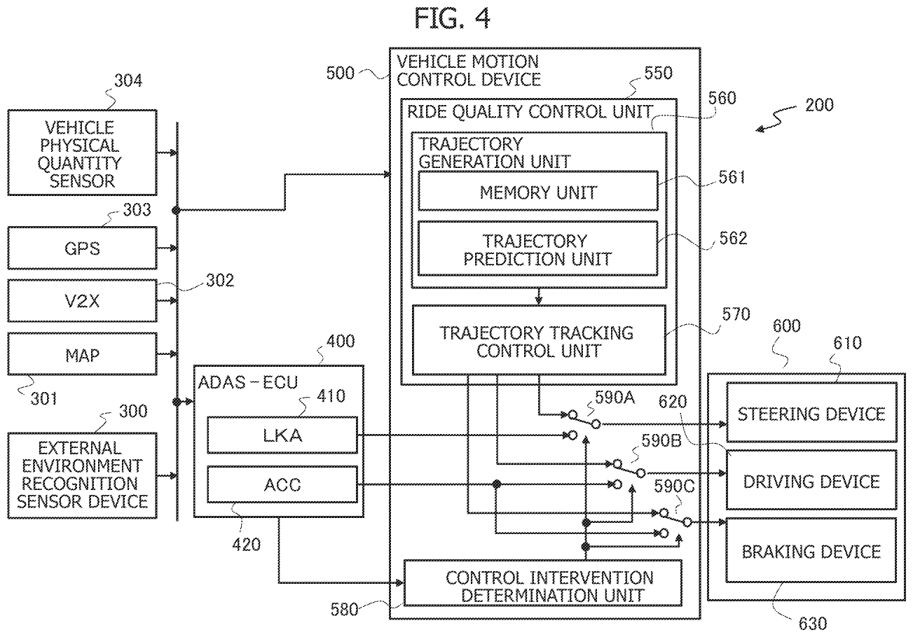

FIG. 4 is a block diagram illustrating more specifically the configuration of vehicle control system 200.

Vehicle control system 200 includes, along with external environment recognition sensor device 300, a map database 301, a V2X module 302, a Global Positioning System (GPS) reception unit 303, and a vehicle physical quantity sensor 304.

Map database 301 is configured in a memory device mounted on vehicle 100. The map information in map database 301 includes information on road location, road shape, and intersection location, etc.

Vehicle-to-everything (V2X) module 302 is a device that allows the microcomputers of ADAS-ECU 400 and vehicle motion control device 500 to communicate with the microcomputers of other vehicles and with roadside devices, which are facilities on the road.

GPS reception unit 303 measures the longitude and latitude of the location of vehicle 100 by receiving signals from a GPS satellite.

Here, vehicle control system 200 refers to map database 301 on the basis of the information on the location of vehicle 100 measured by GPS reception unit 303 to identify the road on which vehicle 100 is traveling and to set a path to the destination of vehicle 100.

Vehicle physical quantity sensor 304 includes a vehicle velocity sensor or a wheel speed sensor to detect the vehicle velocity of vehicle 100.

Furthermore, vehicle physical quantity sensor 304 includes a vehicle behavior sensor that detects any of the front-rear acceleration, left-right acceleration, vertical acceleration, yaw rate, pitch rate, and roll rate of vehicle 100.

Vehicle motion control device 500 includes a ride quality control unit 550 that constitutes a second control command generation unit 530. Ride quality control unit 550 includes a trajectory generation unit 560 and a trajectory tracking control unit 570.

Trajectory generation unit 560 implements trajectory planning for generating a target trajectory for a safe, secure, comfortable, and time-saving travel in accordance with information on the drivable area ahead of vehicle 100.

The target trajectory generated by trajectory generation unit 560 includes information on a target path and a target vehicle velocity.

Here, “safe, secure” means to be capable of avoiding unknown situations and risks with ease, “comfortable” means to provide a comfortable ride for the passengers without their bodies swinging back and forth and from side to side even on curved roads, and “time-saving” means to maintain the highest possible vehicle velocity within regulations and the surrounding environment.

Trajectory generation unit 560 plans a target trajectory using, as a condition, acceleration and jerk in the left-right direction of vehicle 100 in order to achieve a “comfortable” driving, i.e., ride-friendly driving.

That is, in order to reduce acceleration and jerk in the left-right direction compared to those in driving by driver assistance, more specifically, by LKA function 410 and ACC function 420, trajectory generation unit 560 plans a target trajectory such that acceleration and jerk in the left-right direction are each within a predetermined range.

The respective predetermined ranges of acceleration and jerk are each a range that is acceptable in terms of ride quality and that is below the upper tolerance limit.

Trajectory tracking control unit 570 outputs, as an actuator control command, i.e., as the second control command, a steering control command, a driving control command, and a braking control command, for causing vehicle 100 to track the target trajectory planned by trajectory generation unit 560.

In addition, vehicle motion control device 500 includes a control intervention determination unit 580 and three switchers 590A, 590B, and 590C that constitute switching unit 540.

Control intervention determination unit 580 determines whether conditions for intervention of the ride quality control are satisfied. In other words, control intervention determination unit 580 determines whether conditions for outputting, to actuator unit 600, the second control command by the ride quality control, instead of the first control command generated by the driver assistance function by ADAS-ECU 400, are satisfied.

Control intervention determination unit 580 then outputs a switching control signal to each switcher 590A, 590B, and 590C, according to the result of the determination of whether the intervention conditions are satisfied.

Switcher 590A acquires a steering control command output by ADAS-ECU 400 (specifically, LKA function 410) (hereinafter, referred to as first steering control command) and a steering control command output by ride quality control unit 550 (specifically, trajectory tracking control unit 570) (hereinafter, referred to as second steering control command).

When control intervention determination unit 580 determines that intervention conditions of the ride quality control are satisfied, switcher 590A switches the steering control command to be output to steering device 610 from the first steering control command to the second steering control command.

Switcher 590B acquires the driving control command output by ADAS-ECU 400 (specifically, ACC function 420) (hereinafter, referred to as first driving control command) and a driving control command output by ride quality control unit 550 (hereinafter, referred to as second driving control command).

When control intervention determination unit 580 determines that the intervention conditions of the ride quality control are satisfied, switcher 590B switches the driving control command to be output to driving device 620 from the first driving control command to the second driving control command.

Switcher 590C acquires a braking control command output by ADAS-ECU 400 (specifically, ACC function 420) (hereinafter, referred to as first braking control command) and a braking control command output by ride quality control unit 550 (hereinafter, referred to as second braking control command).

When control intervention determination unit 580 determines that intervention conditions of the ride quality control are satisfied, switcher 590C switches the braking control command to be output to braking device 630 from the first braking control command to the second braking control command.

In the following, the process of generating a target trajectory performed by trajectory generation unit 560, in other words, trajectory planning, will be described in detail.

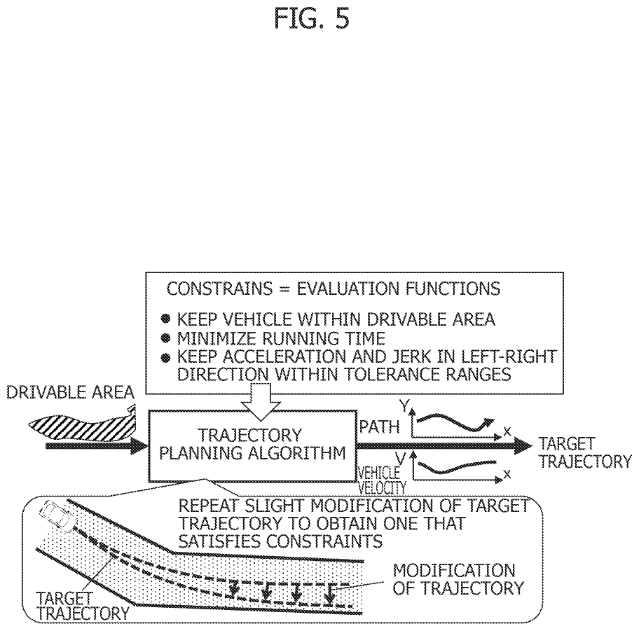

FIG. 5 is a schematic diagram illustrating the process by which trajectory generation unit 560 calculates a target trajectory (target path and target vehicle velocity) using the nonlinear optimization theory.

Trajectory generation unit 560 performs trajectory calculation using a known nonlinear optimization method, such as the quasi-Newton method, thereby determining the target trajectory as an optimized solution that satisfies multiple conditions.

That is, trajectory generation unit 560 calculates a target trajectory that satisfies the following constraints as a nonlinear optimization problem and that maximizes the evaluation functions.

Constraint 1: [Safe, secure] Keep the vehicle within a drivable area.

Constraint 2: [Time-saving] Minimize the running time.

Constraint 3: [Comfortable] Keep acceleration and jerk in the left-right direction within tolerance ranges.

In this way, when the nonlinear optimization theory is used to calculate the target trajectory, information on the center line serving as a reference is not required, and calculation can be performed independent of the shape of the drivable area.

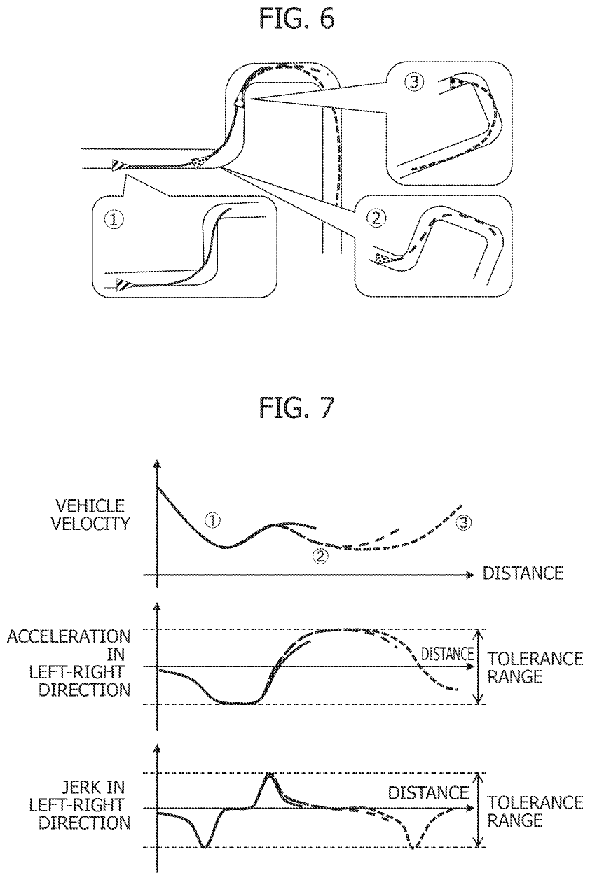

FIGS. 6 and 7 each illustrates, by blocks 1 to 3, an example of calculation of a target trajectory performed by trajectory generation unit 560. FIG. 6 illustrates a target trajectory with respect to the road shape, and FIG. 7 illustrates a target vehicle velocity and changes in acceleration and jerk with respect to the traveled distance of the vehicle tracking the target trajectory.

By calculating the target trajectory in accordance with the constantly varying driving area, trajectory generation unit 560 generates a target trajectory capable of providing a comfortable ride in which acceleration and jerk in the left-right direction of vehicle 100 are kept within tolerance ranges.

Hereinafter, the trajectory switching process performed by trajectory generation unit 560 for smoothly connecting trajectories, from the trajectory based on LKA function 410 and ACC function 420 to the trajectory based on the ride quality control, will be described.

“Smoothly connecting trajectories” means, for example, to switch the trajectory when the derivative value of the curvature of the trajectory is less than a predetermined value, and to switch the trajectory when the jerk in the lateral direction of vehicle 100 is less than a predetermined value.

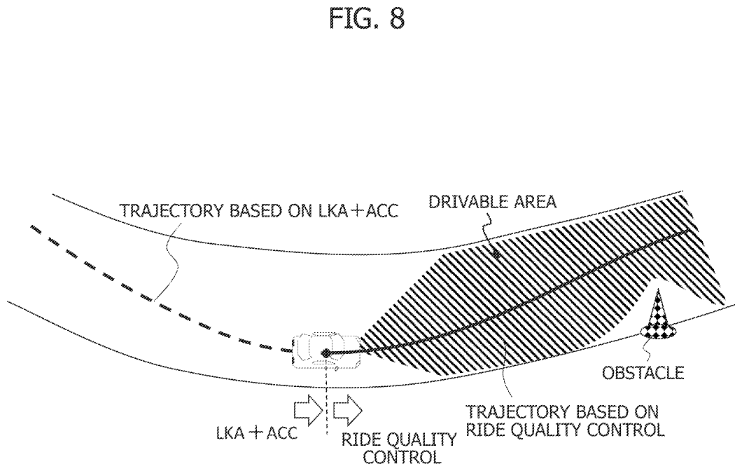

FIG. 8 illustrates the first embodiment of the trajectory switching process for smoothly connecting trajectories.

According to the first embodiment, trajectory generation unit 560 includes a memory unit 561 (see FIG. 4) and stores the trajectory based on LKA function 410 and ACC function 420 in memory unit 561.

Trajectory generation unit 560 then makes a calculation such that the trajectory stored in memory unit 561 smoothly connects to the target trajectory based on the ride quality control.

That is, the control command is switched such that the trajectories are connected when the derivative value of the curvature of the trajectory is less than a predetermined value or when the jerk in the lateral direction of vehicle 100 is less than a predetermined value.

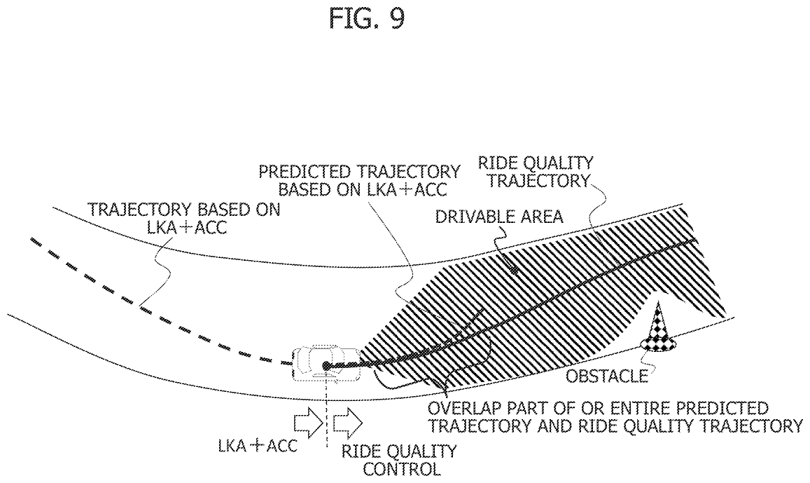

FIG. 9 illustrates the second embodiment of the trajectory switching process for smoothly connecting trajectories.

According to the second embodiment, trajectory generation unit 560 includes a trajectory prediction unit 562 (see FIG. 4) that predicts a future trajectory for the time when the driver assistance by LKA function 410 and ACC function 420 is maintained.

In the second embodiment, the control command is switched based on the predicted trajectory, which is predicted by trajectory prediction unit 562, and based on the second control command.

Trajectory prediction unit 562 predicts the future trajectory on the basis, for example, of the previous trajectory based on LKA function 410 and ACC function 420, the operating state by the driver, and the motion state of vehicle 100.

The operating state by the driver includes any of the steering wheel operation angle, steering wheel operation force, brake pedal depression, and accelerator pedal depression.

The motion state of vehicle 100 includes any of the vehicle velocity, yaw rate, and left-right and front-rear accelerations.

Trajectory generation unit 560 generates a target trajectory based on the ride quality control such that a part of the target trajectory based on the ride quality control overlaps a part of or the entire trajectory predicted by trajectory prediction unit 562.

That is, the control command to be output to actuator unit 600 is switched from the first control command to the second control command such that the trajectory based on the second control command (in other words, ride quality trajectory) overlaps at least part of the predicted trajectory.

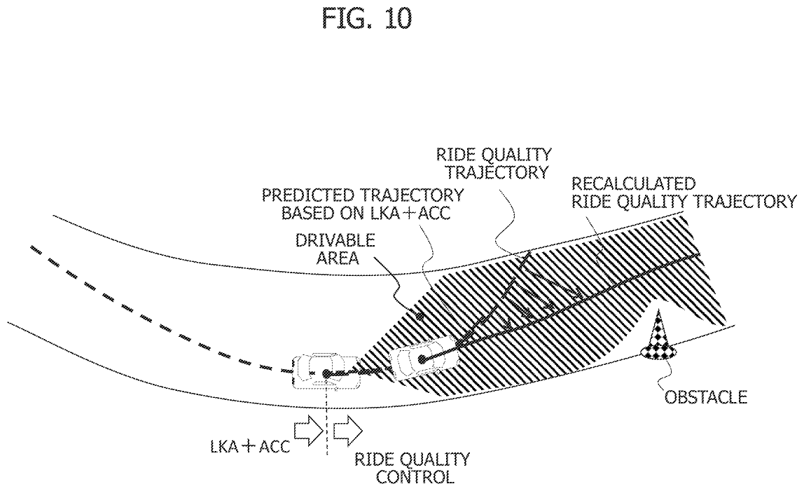

FIG. 10 illustrates the third embodiment of the trajectory switching process for smoothly connecting trajectories.

According to the third embodiment, trajectory generation unit 560 includes trajectory prediction unit 562 (see FIG. 4) as in the second embodiment illustrated in FIG. 9.

Immediately after the switching from the driver assistance by LKA function 410 and ACC function 420 to the ride quality control, trajectory generation unit 560 uses the trajectory predicted by trajectory prediction unit 562 as the target trajectory and causes vehicle 100 to track the predicted trajectory.

Trajectory generation unit 560 then switches the control command such that the trajectory gradually shifts from the predicted trajectory to the trajectory based on the ride quality control.

FIGS. 8 to 10 illustrate the process at the time of switching from the driver assistance control by LKA function 410 and ACC function 420 to the ride quality control, in other words, at the time of switching from the first control command to the second control command. However, vehicle motion control device 500 can also perform the same switching process as in the first to the third embodiments when switching in the reverse direction.

That is, the trajectory switching process for smoothly connecting trajectories using memory unit 561 and trajectory prediction unit 562, as shown in FIGS. 8 to 10, can be applied to return the control from the ride quality control to the driver assistance control by LKA function 410 and ACC function 420, in other words, to switch the control command from the second control command to the first control command.

Next, trajectory tracking control unit 570 will be described in detail.

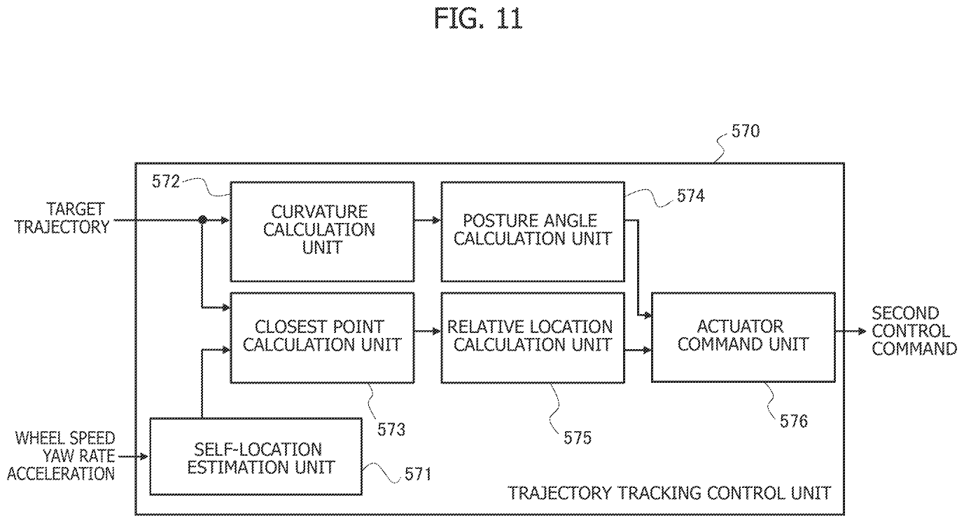

FIG. 11 is a block diagram illustrating an aspect of trajectory tracking control unit 570.

Trajectory tracking control unit 570 includes a self-location estimation unit 571, a curvature calculation unit 572, a closest point calculation unit 573, a posture angle calculation unit 574, a relative location calculation unit 575, and an actuator command unit 576.

Self-location estimation unit 571 estimates the location of vehicle 100 by performing dead reckoning, based on integral values of the wheel speed, yaw rate, longitudinal acceleration, and lateral acceleration, etc.

Trajectory tracking control unit 570 can identify the position of vehicle 100 using GPS.

Curvature calculation unit 572 acquires information about the target trajectory from trajectory generation unit 560 and calculates the curvature and change of the curvature.

Closest point calculation unit 573 calculates the closest point (in other words, the closest target location), which is the point closest to the location of vehicle 100 on the target trajectory.

Posture angle calculation unit 574 calculates the posture angle of vehicle 100 necessary for matching the traveling direction of vehicle 100 at the closest point with the yaw angle at the closest point (i.e., the direction of tangent of the target trajectory), in accordance with the curvature of the target trajectory and change of the curvature.

Relative location calculation unit 575 calculates the relative location of the closest point with respect to the location of vehicle 100.

Actuator command unit 576 corrects the yaw angle at the closest point in accordance with the posture angle calculated by posture angle calculation unit 574.

Actuator command unit 576 then generates a steering command and an acceleration command (in other words, a driving command) or a deceleration command (in other words, a braking command) in accordance with the relative position of the closest point of contact for causing vehicle 100 to pass through the closest point at the target vehicle velocity and the corrected yaw angle, that is, for causing vehicle 100 to track the target trajectory.

Next, the process of determining intervention conditions of the ride quality control performed by control intervention determination unit 580 will be described in detail.

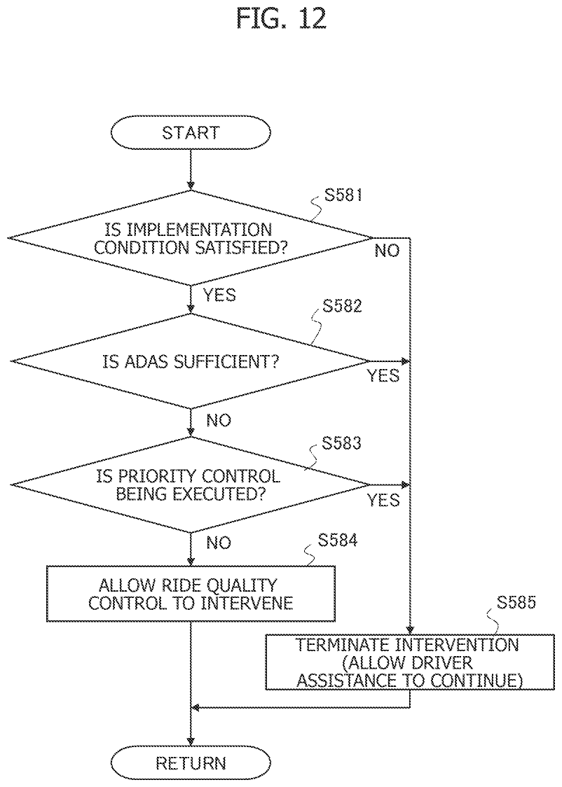

FIG. 12 is a flowchart illustrating the intervention condition determination process performed by control intervention determination unit 580.

First, in step S581, control intervention determination unit 580 determines, based on the forward information of the vehicle, whether a condition for implementing the ride quality control is satisfied.

Here, for example, when the recognized forward information of vehicle 100 cannot be used, control intervention determination unit 580 determines that the condition for implementing the ride quality control is not satisfied.

In addition, for example, when the shape of the drivable area ahead of vehicle 100 is too complex to calculate a path, control intervention determination unit 580 determines that condition for implementing the ride quality control is not satisfied.

When it is determined in step S581 that the condition for implementing the ride quality control is not satisfied (in other words, the condition for the intervention of the ride quality control is not satisfied), the process proceeds to step S585 and control intervention determination unit 580 allows the driver assistance function such as LKA function 410 and ACC function 420 to continue without allowing the ride quality control to intervene.

That is, when the process proceeds to step S585, control intervention determination unit 580 outputs signals to switchers 590A, 590B, and 590C in accordance with the result of determination that the intervention condition of the ride quality control is not satisfied. As a result, switching from the first control command to the second control command is not executed and the first control command continues to be output to actuator unit 600.

On the other hand, when control intervention determination unit 580 determines in step S581 that the condition for implementing the ride quality control is satisfied, the process proceeds to step S582 and control intervention determination unit 580 performs an additional condition determination.

In step S582, control intervention determination unit 580 determines whether it is enough for vehicle 100 to travel by the driver assistance function, in other words, whether the desired effect can be obtained by the ride quality control.

Here, for example, when the road on which vehicle 100 is traveling is an expressway and vehicle 100 has no choice but to travel in the center of the lane, control intervention determination unit 580 determines that it is sufficient for vehicle 100 to travel by the driver assistance function.

In addition, for example, when the road curvature is below a predetermined value and no improvement in ride quality (in other words, suppression of lateral acceleration and jerk) can be expected by modifying the path, control intervention determination unit 580 determines that it is sufficient for vehicle 100 to travel by the driver assistance function.

When it is determined in step S582 that it is sufficient for vehicle 100 to travel by the driver assistance function, in other words, that necessity of the intervention of the ride quality control is low, the process proceeds to step S585 and control intervention determination unit 580 allows the driver assistance functions such as LKA function 410 and ACC function 420 to continue without allowing the ride quality control to intervene.

On the other hand, when it is determined in step S582 that improvement of ride quality is expected by allowing the ride quality control to intervene, the process proceeds to step S583 and control intervention determination unit 580 performs an additional condition determination.

In step S583, control intervention determination unit 580 determines whether a predetermined vehicle motion having priority over ride quality is required.

Here, the state in which a predetermined vehicle motion having priority over ride quality is required means, for example, a state in which a driver assistance function other than LKA function 410 and ACC function 420 is performed, a situation in which the driver performs a driving operation, or a state in which a safety function is performed.

The driver assistance function other than LKA function 410 and ACC function 420 includes a parking assistance function and a collision safety function such as a collision avoidance assistance or a collision mitigation braking.

Driving operation by the driver includes an operation of the steering wheel, brake pedal and accelerator pedal by the driver.

The safety function includes a function called Anti-lock Braking System (ABS), i.e., a function of reducing the occurrence of sliding due to wheel lock, and a function called Electronic Stability Control (ESC), i.e., a function of deterring skidding of vehicle 100.

When it is determined in step S583 that a predetermined vehicle motion having priority over ride quality is required, the process proceeds to step S585 and control intervention determination unit 580 allows the driver assistance function such as LKA function 410 and ACC function 420 to continue without allowing the ride quality control to intervene.

On the other hand, when it is determined in step S583 that a predetermined vehicle motion having priority over the ride quality control is not required, control intervention determination unit 580 determines that the condition for the intervention of the ride quality control is satisfied and the process proceeds to step S584. In step S584, control intervention determination unit 580 sets a setting to allow the ride quality control to intervene.

That is, when the process proceeds to step S584, control intervention determination unit 580 outputs signals to switchers 590A, 590B, and 590C in accordance with the result of determination that the intervention conditions of the ride quality control are satisfied. As a result, the control command to be output to actuator unit 600 is switched from the first control command to the second control command, and accordingly, the ride quality control is implemented.

When, after the shift to the ride quality control, the forward information of vehicle 100 no longer satisfies the predetermined condition, for example, because the road curvature becomes less than the predetermined value, the process proceeds to step S585 and control intervention determination unit 580 terminates the ride quality control.

In addition, when, for example, a safety function such as ESC is activated after the shift to the ride quality control, the process proceeds to step S585 and control intervention determination unit 580 terminates the ride quality control.

Furthermore, when, for example, the driver performs a steering operation after the shift to the ride quality control, the process proceeds to step S585 and control intervention determination unit 580 terminates the ride quality control.

Next, the process performed when vehicle motion control device 500 cancels the intervention of the ride quality control to return the control to the control by a function such as LKA function 410 and ACC function 420 will be described.

As shown in FIGS. 8 to 10, when allowing the ride quality control to intervene, vehicle motion control device 500 connects the trajectory based on the function such as LKA function 410 and ACC function 420 to the trajectory based on the ride quality control.

On the other hand, when cancelling the ride quality control, vehicle motion control device 500 gradually changes the control command to be output to actuator unit 600 from the second control command based on the ride quality control to the first control command based on the function such as LKA function 410 and ACC function 420.

Switchers 590A, 590B, and 590C may have such function of gradually shifting from the second control command to the first control command.

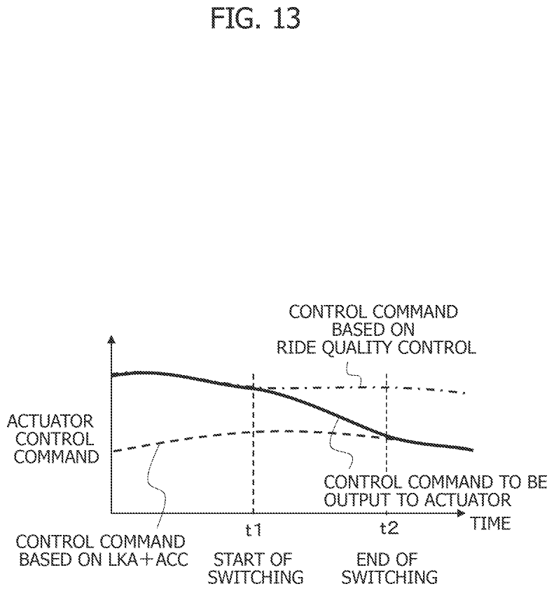

FIG. 13 is a time chart illustrating the shift of the control command at the time of cancellation of the intervention of the ride quality control.

When the condition for cancelling the intervention of the ride quality control is satisfied at time t1, vehicle motion control device 500 starts processing for gradually shifting the control command to be output to actuator unit 600 from the second control command based on the ride quality control to the first control command based on the function such as LKA function 410 and ACC function 420.

Vehicle motion control device 500 shifts the control command to be output to actuator unit 600 from the second control command to the first control command over several seconds, and at time t2, the control command to be output to actuator unit 600 is returned to the first control command.

In this way, vehicle motion control device 500 gradually shifts the control command from the second control command to the first control command, thereby suppressing a rapid change of the vehicle behavior caused by switching the control command, resulting in reducing discomfort for the passengers due to the switching of the control command.

Vehicle motion control device 500 may change the time taken for shifting the control signal from the second control command to the first control command, i.e., the speed of shifting of the control command at which the control command is shifted from the second control command to the first control command, depending on the condition that caused the cancellation.

Specifically, in a case in which the condition for cancelling the intervention of the ride quality control is satisfied because of the execution of a collision safety function or a safety function such as ABS or ESC, vehicle motion control device 500 can shorten the time taken for shifting the control signal from the second control command to the first control command (time Δt from time t1 to time t2 in FIG. 13) than in a case in which cancelling is executed in accordance with other cancellation conditions.

The technical ideas described in the above embodiments may be used in any appropriate combination as long as they do not conflict with each other.

Although the present invention is specifically described above with reference to preferred embodiments, it is apparent to one skilled in the art that variations of the embodiments can be made on the basis of the basic technical concept and the teachings of the present invention.

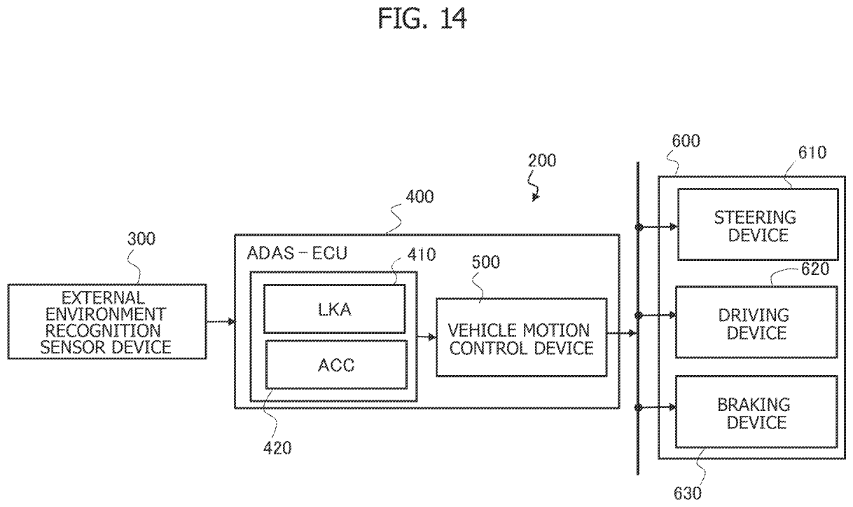

Vehicle control system 200 illustrated in FIG. 1 includes ADAS-ECU 400 and vehicle motion control device 500 as separate units. However, ADAS-ECU 400 may have the function of vehicle motion control device 500, i.e., the function of the ride quality control. FIG. 14 is a functional block diagram illustrating the case in which ADAS-ECU 400 has the function of vehicle motion control device 500.

Here, ADAS-ECU 400 may include a first microcomputer that executes calculation processing for the driver assistance control and a second microcomputer that executes calculation processing for the ride quality control.

In addition, one microcomputer provided in ADAS-ECU 400 may execute the calculation processing for the driver assistance control and the calculation processing for the ride quality control.

In addition to LKA function 410 and ACC function 420, ADAS-ECU 400 may have an autonomous driving function of performing automatic passing on an expressway and a function of automatically performing branching and merging on an expressway.

In addition, actuator unit 600 may include an active suspension with an energy source such as hydraulic or pneumatic pressure. Vehicle motion control device 500 may output, in the ride quality control, a command, such as a command for controlling a damping force of a damper, to the active suspension.

In addition, when multiple driving modes are available for vehicle 100, vehicle motion control device 500 may carry out the intervention of the ride quality control on a condition that a “comfort” mode, in which ride quality is prioritized, is selected.

In addition, vehicle motion control device 500 may calculate either one of the path and the vehicle velocity to reduce acceleration and jerk in the left-right direction in the ride quality control and output accordingly the control command (second control command) to actuator unit 600 to achieve the calculated target.

### REFERENCE SYMBOL LIST

100 Vehicle
200 Vehicle control system
300 External environment recognition sensor device
400 Driver assistance control unit (ADAS-ECU, first control unit)
410 Lane Keeping Assist function (LKA function)
420 Adaptive Cruise Control function (ACC function)
500 Vehicle motion control device (vehicle control device, second control unit)
510 Forward information acquisition unit
520 First control command acquisition unit
530 Second control command generation unit
540 Switching unit
600 Actuator unit
610 Steering device
620 Driving device
630 Braking device

1. A vehicle control device comprising:
a forward information acquisition unit that acquires forward information of a vehicle;
a first control command acquisition unit that acquires a first control command, the first control command being a control command related to driver assistance or autonomous driving of the vehicle;
a second control command generation unit that generates a second control command, the second control command being a control command for setting the vehicle in motion based on an indicator different from that of the first control command; and
a switching unit that, when the forward information of the vehicle satisfies a predetermined condition, switches a control command to be output to an actuator unit for controlling motion of the vehicle from the first control command to the second control command.

2. The vehicle control device according to claim 1,
wherein the first control command is based on a path along a road shape, an inter-vehicle distance, or a set velocity, and
wherein the second control command is based on a trajectory planned using, as a condition, an acceleration in a left-right direction of the vehicle or a jerk in a left-right direction of the vehicle.

3. The vehicle control device according to claim 1,
wherein, when at least one of the forward information of the vehicle does not satisfy a predetermined condition and when a predetermined vehicle motion is required, the switching unit switches the control command to be output to the actuator from the second control command to the first control command.

4. The vehicle control device according to claim 3,
wherein the switching unit switches, in accordance with information in a memory unit that stores a trajectory in an output state of one of the first control command and the second control command, the control command to be output to the actuator unit, from one of the first control command and the second control command to the other of the first control command and the second control command, such that trajectories are connected when a derivative value of a curvature of a path is less than a predetermined value or when a jerk in a left-right direction of the vehicle is less than a predetermined value.

5. The vehicle control device according to claim 3,
wherein the switching unit calculates a predicted trajectory, which is a trajectory predicted based on one of the first control command and the second control command, and in accordance with the predicted trajectory and the other of the first control command and the second control command, the switching unit switches the control command to be output to the actuator unit, from the one of the first control command and the second control command to the other of the first control command and the second control command.

6. The vehicle control device according to claim 5,
wherein the switching unit switches the control command to be output to the actuator unit from the one of the first control command and the second control command to the other of the first control command and the second control command such that the trajectory based on the other of the first control command and the second control command overlaps at least part of the predicted trajectory.

7. The vehicle control device according to claim 5,
wherein the switching unit switches the control command to be output to the actuator unit from the one of the first control command and the second control command to the other of the first control command and the second control command such that a trajectory for the vehicle gradually shifts from the predicted trajectory to the trajectory based on the other of the first control command and the second control command.

8. The vehicle control device according to claim 3,
wherein, when a driver of the vehicle performs a steering operation, the switching unit switches the control command to be output to the actuator unit from the second control command to the first control command.

9. The vehicle control device according to claim 1,
wherein the switching unit switches, in accordance with information in a memory unit that stores a trajectory in an output state of the first control command, the control command to be output to the actuator unit, from the first control command to the second control command, such that trajectories are connected when a derivative value of a curvature of a path is less than a predetermined value or when a jerk in a left-right direction of the vehicle is less than a predetermined value.

10. The vehicle control device according to claim 1,
wherein the switching unit calculates a predicted trajectory, which is a trajectory predicted based on the first control command, and in accordance with the predicted trajectory and the second control command, the switching unit switches the control command to be output to the actuator unit from the one of the first control command and the second control command to the other of the first control command and the second control command.

11. The vehicle control device according to claim 10,
wherein the switching unit switches the control command to be output to the actuator unit from the first control command to the second control command such that the trajectory based on the second control command overlaps at least part of the predicted trajectory.

12. The vehicle control device according to claim 10,
wherein the switching unit switches the control command to be output to the actuator unit from the first control command to the second control command such that a trajectory for the vehicle gradually shifts from the predicted trajectory to the trajectory based on the second control command.

13. A vehicle control method comprising the steps of:
acquiring forward information of a vehicle;
acquiring a first control command, the first control command being a control command related to driver assistance or autonomous driving of the vehicle;
generating a second control command, the second control command being a control command for setting the vehicle in motion based on an indicator different from that of the first control command; and
when the forward information of the vehicle satisfies a predetermined condition, switching a control command to be output to an actuator unit for controlling motion of the vehicle from the first control command to the second control command.

14. A vehicle control system comprising:
an external environment recognition sensor device that acquires forward information of a vehicle;
a first control unit that generates a first control command, the first control command being a control command related to driver assistance or autonomous driving of the vehicle;
a second control unit that generates a second control command, the second control command being a control command for setting the vehicle in motion based on an indicator different from that of the first control command, and that, when the forward information of the vehicle acquired by the external environment recognition sensor device satisfies a predetermined condition, switches a control command to be output from the first control command to the second control command; and
an actuator unit that acquires the control command output from the second control unit and controls motion of the vehicle in response to the control command.
